(19) United States
(12) Patent Application Publication
(10) Pub. No.: US 2026/0253559 A1
(43) Pub. Date: Aug. 27, 2026

(54) DISPLAY DEVICE, IN PARTICULAR FOR A VEHICLE, FOR DISPLAYING INFORMATION, HAVING SWITCHABLE SHARING AND PRIVATE MODES

(71) Applicant: BHTC GmbH, Lippstadt (DE)

(72) Inventors: Alberto SANCHEZ CASTILLO, Lippstadt (DE); Lars WIEHEMEIER, Lippstadt (DE)

(21) Appl. No.: 18/870,776

(22) PCT Filed: Jun. 1, 2023
(86) PCT No.: PCT/EP2023/064742

§ 371 Date: Dec. 2, 2024

(30) Foreign Application Priority Data
Jun. 3, 2022 (DE) 10 2022 114 153.5

(51) Int. Cl. G09G 3/34; B60K 35/22; G02F 1/1335; G02F 1/13357; G09G 3/36

(52) U.S. Cl. CPC G09G 3/3406; B60K 35/22; G02F 1/133603; G02F 1/133627; B60K 2360/1438; B60K 2360/332; B60K 2360/336; B60K 2360/349; G09G 3/36; G09G 2310/04; G09G 2320/0606; G09G 2354/00; G09G 2358/00

(57) ABSTRACT

The invention relates to a display device, in particular for a vehicle, for displaying information, comprising an electronic display with a front face, which has a display surface, and a rear face facing away from the front face, and comprising a backlighting unit for backlighting the display, said backlighting unit having a light output face arranged so as to face the rear face of the display. The display device additionally has an optoelectronic panel which is arranged between the display and the backlighting unit wherein the optoelectronic panel has a plurality of areas which can be operated independently of one another and in which light coming from the backlighting unit can be relayed to display regions, which are flush with said areas, in a bundled manner in order to make the information displayed on the display surface visible during an operation in a private mode and to display regions, which are flush with said areas, in a scattered manner in order to make the information displayed on the display surface visible during an operation in a sharing mode. The display device lastly also comprises an electronic actuation unit for actuating both the optoelectronic panel for operating regions in the private mode or in the sharing mode as well as the display and the backlighting unit.

The invention relates to a display device, in particular for a vehicle, for displaying information either in a private mode or in a sharing mode.

In recent years, the number of display devices and their size in the vehicle have constantly increased. Modern concepts include display devices that extend over the entire width of the instrument panel. Further, proposed designs are known, in which separate display devices are arranged both on the driver side and the passenger side.

For safety reasons, it should not be possible for the driver of a vehicle to be distracted by such information as is displayed on a display device associated to the driver or in an area of a display device associated to the passenger.

A display device is known from US-A-2020/0319512, in which the light leaving the display surface is emitted either in a scattered or a collimated manner, viewed across the entire display surface. The backlighting unit of the known display device comprises individually controllable light sources that are dimmable. In this way, individual areas of the display surface can be darkened, so that, in case of collimated light, these areas are substantially no longer visible from a point located beside the display surface.

WO-A-2018/185476 describes an illumination system for a display device comprising a plurality of catadioptric elements.

A touchscreen with the possibility of operating in a private mode is described in U.S. Pat. No. B11,187,945.

Finally, US-A-2018/0082068 shows a display device with a dynamic private mode filter.

It is an object of the invention to provide a display device, in particular for a vehicle, with which it is possible to optionally minimize the visibility of displayed information when viewing the display device or an area of the display device from the side, in particular from the driver's side.

To achieve this object, the invention proposes a display device, in particular for a vehicle, for displaying information, the display device being provided with
an electronic display with a front face, which has a display surface, and a rear face facing away from the front face,
a backlighting unit for backlighting the display, said backlighting unit having a light output face arranged so as to face the rear face of the display,
an optoelectronic panel which is arranged between the display and the backlighting unit, wherein the optoelectronic panel comprises at least two or more than two areas adapted to be operated independently either in a private mode or in a sharing mode, in which modes light impinging from the backlighting unit is transmittable in a collimated manner to regions of the display, each flush with these areas, for the visibility of information displayed on the display surface, when operated in the private mode, and is transmittable in a scattered manner to regions of the display, each flush with these areas, for the visibility of information displayed on the display surface, when operated in the sharing mode,
an electronic control unit for controlling both the optoelectronic panel for operating regions in the private mode or in the sharing mode as well as the display and the backlighting unit.

The concept according to the invention primarily uses an optoelectronic panel, which is arranged between the electronic display of the display device and its backlighting unit. Using optoelectronic panel, it is possible to transmit light impinging from the backlighting unit the display either bundled (referred to above and below as “collimated”) or scattered in independently controllable and therefore differently operable areas. Regions of the display which backlight arrives collimated enable the displayed information to be well visible across an angle of view which is restricted compared to the angle of view obtained when the region of the display is backlit with scattered light from the backlighting unit. For an example an optoelectronic panel used in accordance with the invention, reference is made to the known concepts based on liquid crystal cells. Backlighting regions of the display with bundled light corresponds to the operation of the display device or of regions of the display in the private mode, whereas the operation in the sharing mode is implemented when the display is backlit with scattered light.

According to the invention, it is thus possible to operate the display surface locally, i.e. in certain zones or regions, in the sharing mode or in the private mode. The optoelectronic panel or, expressed more generally, a layer in e.g. liquid crystal (LC) technology, which makes it possible to collimate or scatter the light passing through the same by electrically controlling areas of the panel, is used for this purpose. The layer or the optoelectronic panel is divided into individual “pixels” for this purpose, which can be controlled individually, wherein one pixel or several pixels form areas that can be controlled independently of each other.

The optoelectronic panel can be designed in particular as described as an example in DE-A-10 2020 100 709. Accordingly, the optoelectronic panel comprises a first polarizer, a second polarizer, a first liquid crystal layer, a first alignment layer and a second alignment layer. The first polarizer and the second polarizer are arranged one behind the other along the optical axis of the light. The first liquid crystal layer is located between the first polarizer and the second polarizer. The first alignment layer is located between the first polarizer and the first liquid crystal layer, while the second alignment layer is located between the second polarizer and the first liquid crystal layer. The alignment direction of the first alignment layer is perpendicular to the alignment direction of the second alignment layer.

As an alternative, two of the aforementioned “optical stacks” can be arranged one behind the other and together form the optoelectronic panel of the display device according to the invention.

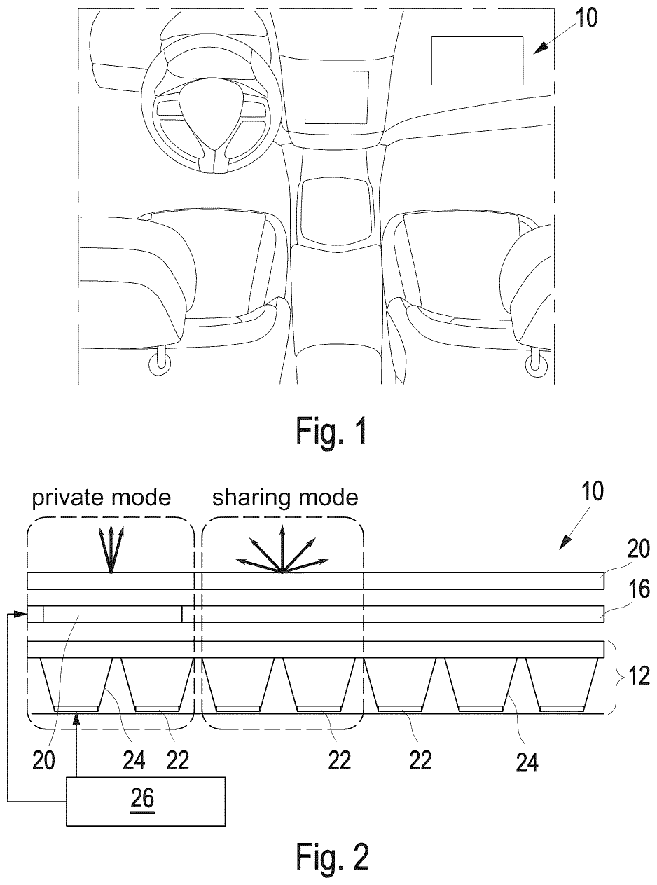

For further details of the above-described exemplary structure of the optoelectronic panel according to the two variants, reference is made to DE-A-10 2020 100 790 (see in particular FIGS. 1 and 6 with associated description), the content of which is hereby incorporated by reference into the subject matter of the present PCT application.

In an expedient development of the invention, it may be provided that the backlighting unit has a plurality of light sources, of which in each case at least one or in each case a group of light sources is assigned to a different one of the independently controllable areas of the optoelectronic panel, and that the at least one light source or the light sources of a respective group which is assigned to an area of the optoelectronic panel to be operated in private mode can be dimmed by means of the control unit. In this further development of the invention, the visibility of information displayed on the display device is further reduced by local dimming of the backlight. This is achieved, for example, by using a backlighting unit that comprises a large number of light sources, each light source having one or more illuminants and a reflector. The light sources are preferably LEDs. In those regions of the display whose associated light sources are dimmed, the information on the display device is correspondingly less illuminated. As such, the backlighting of the entire display is modulated in terms of the degree of brightness. This takes place when selected areas of the optoelectronic panel are operated in private mode. As such, the control unit controls the optoelectronic panel and the backlighting unit in a manner correspondingly matched to each other.

In a further advantageous embodiment of the invention, it may be provided that the backlighting unit comprises a light guide and/or an optical film and/or a diffusor film as well as light sources, and is arranged on the rear side of the light guide and/or the optical film and/or the diffusor film, which faces away from the optoelectronic panel, or is arranged at a distance therefrom and facing the same. The light sources can comprise illuminants in the form of LEDs and reflectors, for example. The use of a light guide and/or an optical film and/or a diffusor film when the light sources are arranged on their respective rear sides (so-called direct backlight unit) may make it necessary to homogenize the emitted light by applying shading or incorporating structures into the light emission side in order to avoid bright points of light on the light emission side. Examples of such measures are described in DE 10 2020 131 013 A1 and U.S. Pat. No. 8,388,159 B2.

As already described above, a feature of the invention is that those regions of the display which are to be operated in private mode can be selected or even chosen. This includes a variant in which the individual regions are defined in advance, but also variants in which the regions can be selected at will by the operator, which is possible, for example, by entering parameters defining the individual regions or, in the case of a display device with touch sensors, by tapping or by marking regions by moving an object on the display surface.

If necessary, the display device according to the invention can additionally be provided with features that are provided with a backlighting unit that ensures asymmetrical light distribution. Possibly, the asymmetrical light distribution can not be influenced in the sense that it can be “symmetrized”. This means that the luminance in the area that is less light-intensive in private mode is generally low. In the sharing mode, by increasing the light intensity of the light sources, it can then be ensured that the display is backlit in a way that meets the requirements of automotive applications in particular.

The invention is described in more detail below by means of an exemplary embodiment and with reference to the drawing. In detail, the Figures show:

FIG. 1 a view from the rear side and from the top on the front interior of a vehicle,

FIG. 2 a schematic illustration of the switching possibility of individual regions of the display between “bundled light transmission” and “scattered light transmission”,

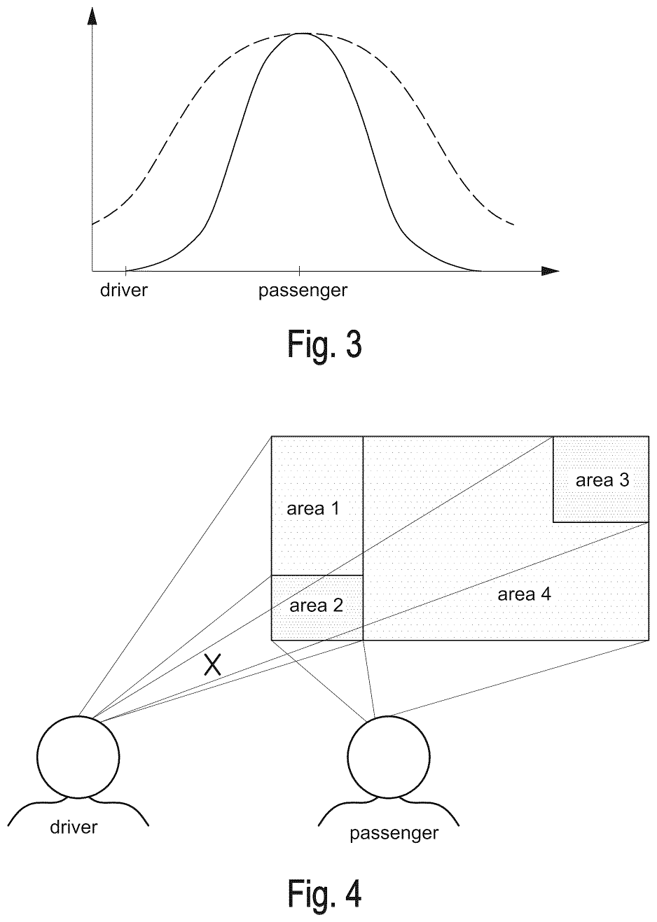

FIG. 3 light distribution graphs in the sharing mode (dash-line graph) and in the private mode (solid-line graph),

FIG. 4 a schematic representation of the situation in which the visibility of individual areas (segments) of the display surface is more limited for the driver than for the passenger, and

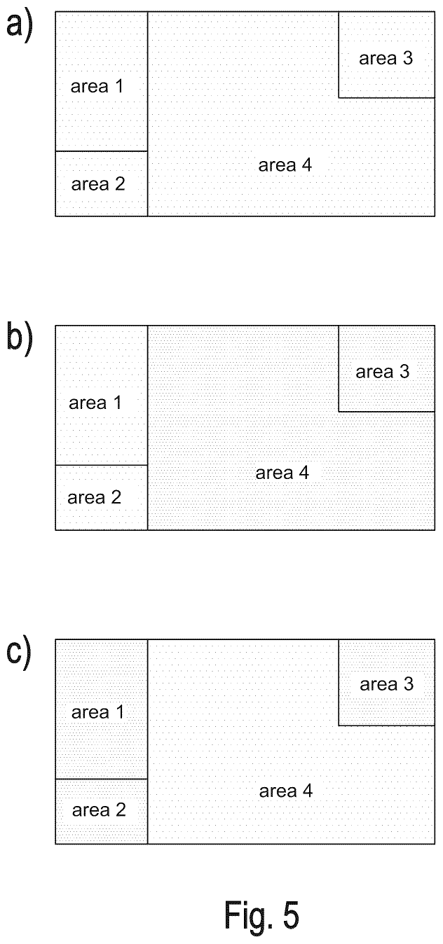

FIG. 5 various scenarios for selecting areas of the display surface for operation in the sharing mode or for the simultaneous operation of areas in the private mode and other areas in the sharing mode.

Privacy functions for displays exist for several years, especially in the consumer market. In the simplest implementations, a static privacy effect is achieved by reducing the viewing angle of the display, e.g. by using light control films.

Another approach is to dynamically activate and deactivate privacy functions, e.g. by using a dual backlighting system. In the sharing mode, a “normal” viewing experience is possible because of an illumination over a wide viewing angle, while in the private mode a more collimated or focused light emission is used. In this way, only viewers who are located in the propagation direction of the collimated light can comfortably see the content.

However, these approaches often have a certain luminance outside the intended viewing angle as well. Due to the adaptability of the human eye to low light conditions, this leads to a residual visibility of the image and thus to a lack of privacy, especially in dark ambient light conditions.

A preferred application of the invention is in the automotive sector. FIG. 1 shows a view of the front part of a vehicle interior from the rear. An LCD display 10 is located on the passenger side. Now, individual areas can be electively operated in the sharing mode or the private mode on this display. Modern vehicles sometimes have “door-to-door” displays. In this case, the display area located opposite the passenger would be the one in which different areas can be operated in the private mode and the sharing mode.

According to the invention, a direct backlighting system is combined with a segmented, optoelectronic privacy cell panel, so that the privacy effect can be activated independently in discrete areas of the displays 10. The display 10 shown schematically in FIG. 2 has a direct-lit backlighting unit 12, an optical film 14 to increase efficiency, polymer-dispersed liquid crystal (PDLC)-based privacy cells as an example of an optoelectronic panel 16 for “shaping” the emitted light, wherein the privacy cells (indicated at 18 in FIG. 2) can be controlled completely or only in selected areas, as well as a liquid crystal display module 20 (LCD), on whose display surface a touch panel or a cover glass (both not shown) can also be arranged.

In display areas used in the private mode, the emitted light (see the arrows on the left in FIG. 1) is much more directional compared to areas in the sharing mode (see the arrows to the right).

Under viewing angles where the privacy effect comes into play, e.g. when the driver is in a vehicle, the parts of the display that are still in the sharing mode remain clearly visible and thus prevent the eye from fully adapting to the dark state. This reduces the visibility of the segments in the private mode from the driver's viewing angle, which increases the subjective privacy performance and reduces distraction during vehicle operation (FIG. 3).

By using direct backlighting (see in FIG. 2 the light sources 22 with the reflectors 24, if necessary), which can be dimmed locally, a second factor can be used to improve the privacy function of the display: The display areas with activated private mode can be selectively dimmed, so that they are even less visible from the driver's perspective.

In this case, an electronic control unit 26, which controls the optoelectronic panel 16 or its individual privacy cells for operation either in the private mode or in the sharing mode (selectively for each privacy cell), also ensures the dimming of the individual light sources 22, as shown in FIG. 2.

FIG. 3 shows the visibility of display areas from different positions in the vehicle: Areas in the sharing mode (shown in low dot density) show a high light density over the entire viewing angle, resulting in good visibility for both the driver and the front passenger. Display areas in the private mode (shown in higher dot density) also have a good light density for the passenger, but a very low light density in the driver's position and are therefore illegible or less legible from the driver's position. Due to the fact that certain areas of the display or its display surface are still clearly visible to the driver means that his/her eyes cannot fully adjust to the less visible areas that are operated in the private mode. This also increases the privacy performance.

In addition, new applications arise when only some parts of the display are in the private mode (FIG. 4). When using the display for menu navigation, all parts may be visible (FIG. 5a)). Control elements such as the temperature control can remain visible to all vehicle occupants (FIG. 5b), areas 1 and 2), while dynamic content such as films or web activities can be shown in areas 3 and 4 of the display with a privacy function for the driver. Even during menu navigation (FIG. 5c), areas 1 and 4), notifications can be shown in the parts of the display (areas 2 and 3) in the private mode, so as not to distract the driver and to ensure the confidentiality of messages.

The number of segments can be further increased by controlling the segments with a passive or active matrix that corresponds to the number of local dimming zones provided by the direct backlighting.

Basically, according to the invention, switching between the two modes takes place pixel by pixel. Thus, a single pixel can be switched at a time. The areas on the display that can be switched can therefore be controlled and selected as required. Basically, there are as many switchable segments as the display has pixels.

The concept according to the invention can also be combined with other switchable or stationary privacy concepts. Examples of this can be found in German patent application 10 2021 126 024.8 dated Oct. 7, 2021 or in German patent application with the title “Display device, in particular for a vehicle, with switchable sharing and private mode” (attorney's reference: 212844DE; filed on the same day as the present patent application) or in German patent application 10 2021 126 025.6 dated Oct. 7, 2021 or in German patent application entitled “Display device, in particular for a vehicle, for displaying information with asymmetric backlighting” (attorney reference: 212845DE; filed on the same date as the present patent application).

The subject matter of the above-mentioned patent applications is hereby incorporated by reference into the present patent application.

With displays having a switchable privacy function for switching between a sharing mode and a private mode, as provided by the invention, this can be done both manually and automatically. In automotive applications, automatic switching from the sharing mode to the private mode is useful if, for example, a camera observing the driver detects that the driver is looking towards the passenger display or passenger display area (eye tracking). In such cases, however, it would also be useful to automatically switch to the private mode when “moving images” are shown on the passenger display or passenger display area. Thus, there are various approaches for automatically switching from a sharing mode to a private mode. Accordingly, the system is then also automatically reset to the sharing mode. The automatic switching to the private mode can be omitted in vehicles with seat occupancy detection if no passenger seat occupancy is detected.

### LIST OF REFERENCE NUMERALS

10 display
12 backlighting unit
14 optical film
16 optoelectronic panel
18 privacy cells of the optoelectronic panel
20 LCD display
22 light sources
24 reflectors
26 control unit

1. A display device, in particular for a vehicle, for displaying information, comprising
an electronic display with a front face, which has a display surface, and a rear face facing away from the front face,
a backlighting unit for backlighting the display, said backlighting unit having a light output face arranged so as to face the rear face of the display,
an optoelectronic panel which is arranged between the display and the backlighting unit, wherein the optoelectronic panel comprises at least two or more than two areas adapted to be operated independently either in a private mode or in a sharing mode, in which modes light impinging from the backlighting unit is transmittable in a bundled manner to regions of the display, each flush with these areas, for the visibility of information displayed on the display surface, when operated in the private mode, and is transmittable in a scattered manner to regions of the display, each flush with these areas, for the visibility of information displayed on the display surface, when operated in the sharing mode, and
an electronic control unit for controlling both the optoelectronic panel for operating areas in the private mode or in the sharing mode, as well as the display and the backlighting unit.

2. The display device according to claim 1, characterized in that the backlighting unit comprises a light guide and/or an optical film and/or a diffusor film as well as light sources arranged in particular distributed in a matrix shape, and is arranged on the rear side of the light guide and/or the optical film and/or the diffusor film, which faces away from the optoelectronic panel, or is arranged at a distance therefrom and facing the same.

3. The display device of claim 2, characterized in that the light sources comprise illuminants, in particular LEDs, and reflectors.

4. The display device according to claim 1, characterized in that the backlighting unit comprises a plurality of light sources, at least one of which is assigned to one other of the independently operable areas of the optoelectronic panel, respectively, and that the at least one light source which is assigned to an area of the optoelectronic panel to be operated in the private mode, is dimmable by means of the control unit

5. The display device according to claim 1, characterized in that the regions on the display surface can be selected manually for the visibility of the information displayed there in the private mode or in the sharing mode.

6. The display device according to claim 5, characterized in that a touch sensor system is assigned to the display surface and that the regions on the display surface can be selected by being marked through a touch operation.

7. The display device according to claim 2, characterized in that the backlighting unit comprises a plurality of light sources, at least one of which is assigned to one other of the independently operable areas of the optoelectronic panel, respectively, and that the at least one light source which is assigned to an area of the optoelectronic panel to be operated in the private mode, is dimmable by means of the control unit.

8. The display device according to claim 7, characterized in that the light sources comprise illuminants, in particular LEDs, and reflectors.

9. The display device according to claim 2, characterized in that the regions on the display surface can be selected manually for the visibility of the information displayed there in the private mode or in the sharing mode.

10. The display device according to claim 4, characterized in that the regions on the display surface can be selected manually for the visibility of the information displayed there in the private mode or in the sharing mode.
